(19) United States
(12) Patent Application Publication
(10) Pub. No.: US 2022/0335176 A1
(43) Pub. Date: Oct. 20, 2022

(54) SOLAR CALCULATOR

(71) Applicant: RMH Tech LLC, Colorado Springs, CO (US)

(72) Inventors: Dustin M.M. Haddock, Colorado Springs, CO (US); Nikolaus Jo Holley, Colorado Springs, CO (US)

(21) Appl. No.: 17/720,586

(22) Filed: Apr. 14, 2022

Related U.S. Application Data
(60) Provisional application No. 63/174,853, filed on Apr. 14, 2021.

(51) Int. Cl. G06F 30/18; H02S 20/23

(52) U.S. Cl. CPC G06F 30/18; H02S 20/23; G06F 2113/04

(57) ABSTRACT

Embodiments of the present disclosure are directed to a solar calculator which can calculate a layout for a set of solar panels to be installed on a roof of a building. Generally speaking, the solar calculator can receive as input a roof type for the building, system requirements, site information, specifications for mounting hardware to be used, specifications for the solar panels to be used, wind data for the location of the building, etc. From this data, the solar calculator can then calculate the number of solar panels needed, a layout for the panels on the roof, the hardware required to mount the panels, locations for the hardware to be installed, and/or other information. A graphical and/or textual report can then be generated that describes the layout of the solar panels and hardware, a bill of materials for the installation, and other information.

### CROSS REFERENCE

The present application claims the benefits of and priority, under 35 U.S.C. § 119(e), to U.S. Provisional Application No. 63/174,853 filed Apr. 14, 2022 by Haddock et al and entitled “Solar Calculator” of which the entire disclosure is incorporated herein by reference for all purposes.

### FIELD OF THE DISCLOSURE

Embodiments of the present disclosure relate generally to methods and systems for installing solar panels on the roof of a building and more particularly to calculating a layout for a set of solar panels to be installed on a roof of a building.

### BACKGROUND

Installing solar panels onto a roof of a building includes many considerations. For example, arrangement and location of the panels on the roof require considerations of the size and shape of the roof, the roof type, the roof material used, the environmental conditions at the location, etc. Additionally, size, shape, weight, structure, and other physical attributes of the panels vary between different panels and manufacturers. Furthermore, the mountain hardware used varies in physical arrangement and attributes. All of these factors, together with local building codes and requirements must be taken into consideration. Typically, this is a manual process of looking up specifications and codes which can be time consuming and prone to errors. Hence, there is a need for improved methods and systems for calculating a layout for a set of solar panels to be installed on a roof of a building.

### BRIEF SUMMARY

Embodiments of the disclosure provide systems and methods for calculating a layout for a set of solar panels to be installed on a roof of a building. According to one embodiment, a method for calculating a layout for a set of solar panels to be installed on a roof of a building can comprise receiving, by a computing system, input parameters defining requirements for the solar panels. The input parameters can comprise, for example, one or more of project information, roof information for the roof of the building, site information for the building, or system requirements for the solar panels. An aerial image of the roof of the building can be obtained and an available area for the solar panels can be determined based on the aerial image. Structural information for the installation of the solar panels can also be obtained from one or more databases and or from a user. The structural information for the installation of the solar panels can comprise one or more of specifications for hardware to mount the solar panels, specifications for the solar panels, or wind data for the building.

A layout for the solar panels, required hardware for mounting the solar panels on the roof of the building, and locations for the required hardware can be calculated based on the received input parameters, the determined available area for the solar panels, and the obtained structural information for the installation of the solar panels. A report providing the calculated layout and mounting hardware requirements can be generated.

Calculating a layout for the solar panels can comprise aligning a mounting location of each solar panel with a seam of the roof of the building. Calculating required hardware for mounting the solar panels on the roof of the building and locations for the required hardware can be further based on a building code for a geographic region of the building. For example, the layout for the solar panels can comprise a gap between two or more adjacent solar panels and, in such cases, calculating the layout for the solar panels can comprise adjusting the gap between the two or more adjacent solar panels to align a mounting location of each solar panel with a seam of the roof of the building. For example, the gap between the two or more adjacent solar panels can comprise a predetermined distance allowing for thermal expansion of the two or more adjacent solar panels.

In some cases, after calculating the layout for the solar panels, required hardware for mounting the solar panels on the roof of the building, and the locations for the required hardware, an update to the calculated layout for the solar panels can be received. In such cases, a determination can be made as to whether the update to the calculated layout for the solar panels matches a determined layout for the solar panels. In response to determining the update to the calculated layout for the solar panels matches the determined layout for the solar panels, the update to the calculated layout for the solar panels can be provided in the generated report. In response to determining the update to the calculated layout for the solar panels does not match the determined layout for the solar panels, the update to the calculated layout for the solar panels can be adjusted and the adjusted update to the calculated layout for the solar panels can be provided in the generated report.

According to another embodiment, a system can comprise a processor and a memory coupled with and readable by the processor. The memory can store therein a set of instructions which, when executed by the processor, causes the processor to calculate a layout for a set of solar panels to be installed on a roof of a building by receiving input parameters defining requirements for the solar panels, obtaining an aerial image of the roof of the building, determining an available area for the solar panels based on the aerial image, and obtaining structural information for the installation of the solar panels. The input parameters can comprise one or more of project information, roof information for the roof of the building, site information for the building, or system requirements for the solar panels. The structural information for the installation of the solar panels can comprise one or more of specifications for hardware to mount the solar panels, specifications for the solar panels, or wind data for the building.

The instructions can further cause the processor to calculate a layout for the solar panels, required hardware for mounting the solar panels on the roof of the building, and locations for the required hardware based on the received input parameters, the determined available area for the solar panels, and the obtained structural information for the installation of the solar panels and generate a report providing the calculated layout and mounting hardware requirements. Calculating a layout for the solar panels can comprise aligning a mounting location of each solar panel with a seam of the roof of the building. Calculating required hardware for mounting the solar panels on the roof of the building and locations for the required hardware can be further based on a building code for a geographic region of the building. For example, the layout for the solar panels can comprise a gap between two or more adjacent solar panels and, in such cases, calculating the layout for the solar panels can comprise adjusting the gap between the two or more adjacent solar panels to align a mounting location of each solar panel with a seam of the roof of the building. For example, the gap between the two or more adjacent solar panels can comprise a predetermined distance allowing for thermal expansion of the two or more adjacent solar panels.

In some cases, after calculating the layout for the solar panels, required hardware for mounting the solar panels on the roof of the building, and the locations for the required hardware, the instructions can cause the processor to receive an update to the calculated layout for the solar panels. In such cases, the instructions can cause the processor to a determination can be made as to whether the update to the calculated layout for the solar panels matches a determined layout for the solar panels. In response to determining the update to the calculated layout for the solar panels matches the determined layout for the solar panels, the instructions can cause the processor to provide the update to the calculated layout for the solar panels in the generated report. In response to determining the update to the calculated layout for the solar panels does not match the determined layout for the solar panels, the instructions can cause the processor to adjust the update to the calculated layout for the solar panels and provide the adjusted update to the calculated layout for the solar panels in the generated report.

According to yet another embodiment, a non-transitory, computer-readable medium can comprise a set of instructions stored therein which, when executed by a processor, causes the processor to calculate a layout for a set of solar panels to be installed on a roof of a building by receiving input parameters defining requirements for the solar panels, obtaining an aerial image of the roof of the building, determining an available area for the solar panels based on the aerial image, and obtaining structural information for the installation of the solar panels. The input parameters can comprise one or more of project information, roof information for the roof of the building, site information for the building, or system requirements for the solar panels. The structural information for the installation of the solar panels can comprise one or more of specifications for hardware to mount the solar panels, specifications for the solar panels, or wind data for the building.

The instructions can further cause the processor to calculate a layout for the solar panels, required hardware for mounting the solar panels on the roof of the building, and locations for the required hardware based on the received input parameters, the determined available area for the solar panels, and the obtained structural information for the installation of the solar panels and generate a report providing the calculated layout and mounting hardware requirements. Calculating a layout for the solar panels can comprise aligning a mounting location of each solar panel with a seam of the roof of the building. Calculating required hardware for mounting the solar panels on the roof of the building and locations for the required hardware can be further based on a building code for a geographic region of the building. For example, the layout for the solar panels can comprise a gap between two or more adjacent solar panels and, in such cases, calculating the layout for the solar panels can comprise adjusting the gap between the two or more adjacent solar panels to align a mounting location of each solar panel with a seam of the roof of the building. For example, the gap between the two or more adjacent solar panels can comprise a predetermined distance allowing for thermal expansion of the two or more adjacent solar panels.

In some cases, after calculating the layout for the solar panels, required hardware for mounting the solar panels on the roof of the building, and the locations for the required hardware, the instructions can cause the processor to receive an update to the calculated layout for the solar panels. In such cases, the instructions can cause the processor to a determination can be made as to whether the update to the calculated layout for the solar panels matches a determined layout for the solar panels. In response to determining the update to the calculated layout for the solar panels matches the determined layout for the solar panels, the instructions can cause the processor to provide the update to the calculated layout for the solar panels in the generated report. In response to determining the update to the calculated layout for the solar panels does not match the determined layout for the solar panels, the instructions can cause the processor to adjust the update to the calculated layout for the solar panels and provide the adjusted update to the calculated layout for the solar panels in the generated report.

### BRIEF DESCRIPTION OF THE DRAWINGS

FIG. 1 is a diagram illustrating an exemplary building outline of a subject building for various embodiments of the present disclosure.

FIG. 2 is a diagram illustrating exemplary wind zones for an exemplary subject building for various embodiments of the present disclosure.

FIG. 3 is a block diagram illustrating elements of an exemplary computing environment in which embodiments of the present disclosure may be implemented.

FIG. 4 is a block diagram illustrating elements of an exemplary computing device in which embodiments of the present disclosure may be implemented.

FIG. 5 is a screenshot of an exemplary site information input screen according to one embodiment of the present disclosure.

FIG. 6 is a screenshot of an exemplary roof type input screen according to one embodiment of the present disclosure.

FIGS. 7A-7C illustrate examples of reports which can be generated by embodiments of the present disclosure.

FIG. 8 is a flowchart illustrating an exemplary process for calculating a solar panel installation layout according to one embodiment of the present disclosure.

FIG. 9 is a flowchart illustrating additional details of an exemplary process for calculating a solar panel installation layout according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

Embodiments of the present disclosure are directed to a solar calculator which can calculate a layout for a set of solar panels to be installed on a roof of a building. Generally speaking, the solar calculator as described herein can receive as input a roof type for the building, system requirements, site information, and other parameters. The solar calculator can also receive from a user and/or look up in one or more databases additional information including, but not limited to, specifications for mounting hardware to be used, specifications for the solar panels to be used, wind data for the location of the building, etc. From this data, the solar calculator can then calculate the number of solar panels needed, a layout for the panels on the roof, the hardware required to mount the panels, locations for the hardware to be installed, and/or other information. In doing so, the solar calculator can position the solar panels and the mounting hardware on the roof so that the panels and mounting hardware align with seams on the roof so that the hardware can be clamped to the seams of the roof without a need to drill into the roof. According to another embodiment, such as in the case of an exposed fastener roof, the solar calculator can position the panels and hardware to align with the ribs or corrugations of the roof for mounting thereon. A graphical and/or textual report can then be generated and presented on a display device and/or printed. The report can present and describe the layout of the solar panels and hardware, a bill of materials for the installation, and other information.

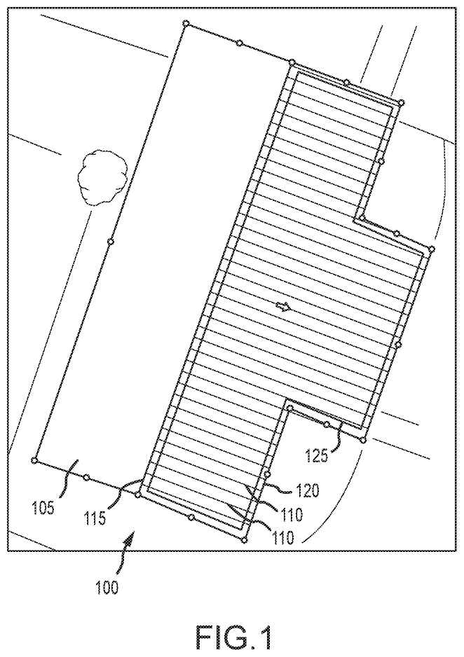

FIG. 1 is a diagram illustrating an exemplary building outline of a subject building for various embodiments of the present disclosure. More specifically, this example illustrates an aerial image of a building 100 upon which solar panels are to be placed. Such an image can be obtained, for example, by a drone, aircraft, satellite or other platform. According to one embodiment, the solar calculator can obtain such an image from an online service providing such images such as Goggle Maps or Google Earth, for example.

Also as illustrated here, the roof 105 of the building 100 can comprise a set of parallel ribs 110 extending between the peak 115 of the roof 105 and the opposite edge 120 of the roof 105. These ribs 110 may be seams between two metal roof panels. According to one embodiment, these seams can be used to mount the solar panels without drilling holes into the roof. More specifically, fasteners comprising clamps adapted to engage and grip the seams can be installed onto the seams at various locations and solar panels can be mounted onto the fasteners. According to another embodiment, such as in the case of an exposed fastener roof, the solar calculator can position the panels and hardware to align with the ribs 110 or corrugations of the roof 105 for mounting thereon. As will be described, the solar calculator can determine the number and location of these fasteners.

Once the image of the roof 105 of the building 100 has been obtained, the solar calculator can identify the edges or outline 125 of the roof 105. This outline 125 can comprise the area available for placement of the solar panels. Accordingly, the solar calculator can calculate the total available area, i.e., within the outline 125 of the roof 105, which, along with other information, can be used to determine the layout for the solar panels. This additional information can include, but is not limited to, roof panel size, i.e., spacing between the seams, type of fasteners to be used to mount the solar panels, requirements for spacing between the solar panels, etc. Such information can be obtained, for example, from a user of the solar calculator and/or from one or more databases maintaining manufacturers information for the type of roof panels installed on the building and/or the type of solar panels which will be used. Based on such information, the solar calculator can position the solar panels and the mounting hardware on the roof 105 so that the panels and mounting hardware align with seams on the roof so that the hardware can be clamped to the seams of the roof without a need to drill into the roof. According to another embodiment, such as in the case of an exposed fastener roof, the solar calculator can position the panels and hardware to align with the ribs 110 or corrugations of the roof 105 for mounting thereon.

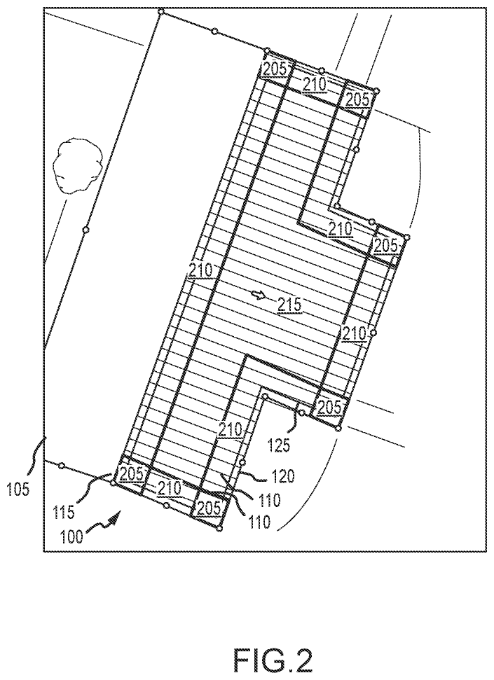

FIG. 2 is a diagram illustrating exemplary wind zones for an exemplary subject building for various embodiments of the present disclosure. According to one embodiment, the solar calculator can also consider dynamic forces such as wind loads on the installed solar panels when determining the number and locations of the fasteners. The overall area of the roof 105 can be divided into a number of zones 205 and 210 having different levels of wind exposure. For example, the corners of the roof can be considered one zone 205 having the highest level of exposure since wind from different directions can affect the panels in these areas. Another zone 210, i.e., the edges of the roof between the corner zones 205, can be considered zones with the next highest loads since these areas are directly exposed to wind but from fewer directions. The middle of the roof between the edge zones 210 can be considered yet another zone 215 which is relatively protected and with little or no loading from wind. In some cases, another zone (not shown here) can be considered to be where two or more other zones 205, 210, and/or 215 meet or cross over since wind loads in these areas may occur from multiple directions and may therefore be increased. Each of these different zones 205, 210, and/or 215 can be handled individually by the solar calculator in determining mounting requirements and layout.

Accordingly, the solar calculator can be adapted to collect wind data for the location of the building as well as other parameters for the location including, but not limited to, wind exposure level, slope of roof, height of the building, risk category, e.g., is the building classified as a critical structure, regulations regarding wind uplift force that structures must be able to withstand, etc. Again, such information can be obtained from a user or from one or more publicly available and/or proprietary databases. The solar calculator can also look up specifications for hardware selected for mounting the solar panels. Once such information has been obtained, the solar calculator can calculate uplift force for each of the various zones of the roof and determine a number of clamps needed per solar panel as well as a spacing between the clamps.

The solar calculator can be implemented as software executing on one or more computing devices. For example, the solar calculator can comprise an application executing on a stand-alone computing device such as a personal computer or a laptop computer. In other cases, the solar calculator may be executed on a server and provided online as software-as-a-service. The one or more databases of various information such as described above can also be maintained locally by a system executing the solar calculator and/or remotely on one or more servers or other systems. Any such variations in implementation are considered to be within the scope of the present disclosure.

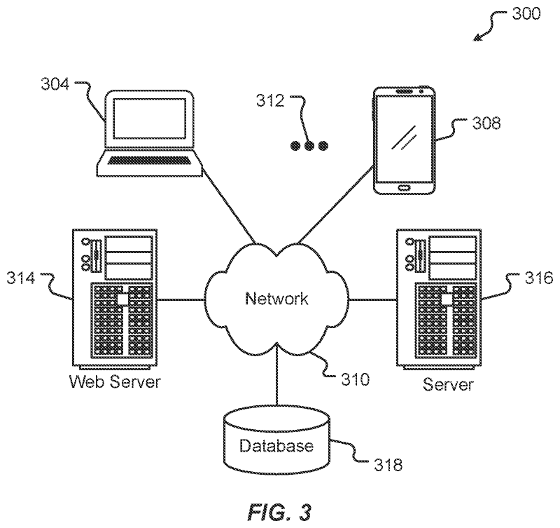

FIG. 3 is a block diagram illustrating elements of an exemplary computing environment in which embodiments of the present disclosure may be implemented. More specifically, this example illustrates a computing environment 300 that may function as the servers, user computers, or other systems provided and described herein. The environment 300 includes one or more user computers, or computing devices, such as a computing device 304, a communication device 308, and/or more 312. The computing devices 304, 308, 312 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 304, 308, 312 may also have any of a variety of applications, including for example, database client and/or server applications, and web browser applications. Alternatively, the computing devices 304, 308, 312 may be any other electronic device, such as a thin-client computer, Internet-enabled mobile telephone, and/or personal digital assistant, capable of communicating via a network 310 and/or displaying and navigating web pages or other types of electronic documents. Although the exemplary computer environment 300 is shown with two computing devices, any number of user computers or computing devices may be supported.

Environment 300 further includes a network 310. The network 310 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 310 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 314, 316. In this example, server 314 is shown as a web server and server 316 is shown as an application server. The web server 314, which may be used to process requests for web pages or other electronic documents from computing devices 304, 308, 312. The web server 314 can be running an operating system including any of those discussed above, as well as any commercially-available server operating systems. The web server 314 can also run a variety of server applications, including SIP servers, HyperText Transfer Protocol (secure) (HTTP(s)) servers, FTP servers, CGI servers, database servers, Java servers, and the like. In some instances, the web server 314 may publish operations available operations as one or more web services.

The environment 300 may also include one or more file and or/application servers 316, which can, in addition to an operating system, include one or more applications accessible by a client running on one or more of the computing devices 304, 308, 312. The server(s) 316 and/or 314 may be one or more general purpose computers capable of executing programs or scripts in response to the computing devices 304, 308, 312. As one example, the server 316, 314 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 316 may also include database servers, including without limitation those commercially available from Oracle®, Microsoft®, Sybase®, IBM® and the like, which can process requests from database clients running on a computing device 304, 308, 312.

The web pages created by the server 314 and/or 316 may be forwarded to a computing device 304, 308, 312 via a web (file) server 314, 316. Similarly, the web server 314 may be able to receive web page requests, web services invocations, and/or input data from a computing device 304, 308, 312 (e.g., a user computer, etc.) and can forward the web page requests and/or input data to the web (application) server 316. In further embodiments, the server 316 may function as a file server. Although for ease of description, FIG. 3 illustrates a separate web server 314 and file/application server 316, those skilled in the art will recognize that the functions described with respect to servers 314, 316 may be performed by a single server and/or a plurality of specialized servers, depending on implementation-specific needs and parameters. The computer systems 304, 308, 312, web (file) server 314 and/or web (application) server 316 may function as the system, devices, or components described herein.

The environment 300 may also include a database 318. The database 318 may reside in a variety of locations. By way of example, database 318 may reside on a storage medium local to (and/or resident in) one or more of the computers 304, 308, 312, 314, 316. Alternatively, it may be remote from any or all of the computers 304, 308, 312, 314, 316, and in communication (e.g., via the network 310) with one or more of these. The database 318 may reside in a Storage-Area Network (SAN) familiar to those skilled in the art. Similarly, any necessary files for performing the functions attributed to the computers 304, 308, 312, 314, 316 may be stored locally on the respective computer and/or remotely, as appropriate. The database 318 may be a relational database, such as Oracle 20i®, that is adapted to store, update, and retrieve data in response to Structured Query Language (SQL) formatted commands.

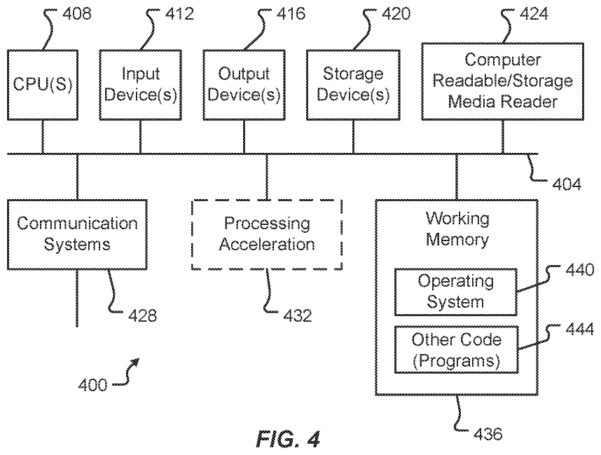

FIG. 4 is a block diagram illustrating elements of an exemplary computing device in which embodiments of the present disclosure may be implemented. More specifically, this example illustrates one embodiment of a computer system 400 upon which the servers, user computers, computing devices, or other systems or components described above may be deployed or executed. The computer system 400 is shown comprising hardware elements that may be electrically coupled via a bus 404. The hardware elements may include one or more Central Processing Units (CPUs) 408; one or more input devices 412 (e.g., a mouse, a keyboard, etc.); and one or more output devices 416 (e.g., a display device, a printer, etc.). The computer system 400 may also include one or more storage devices 420. By way of example, storage device(s) 420 may be disk drives, optical storage devices, solid-state storage devices such as a Random-Access Memory (RAM) and/or a Read-Only Memory (ROM), which can be programmable, flash-updateable and/or the like.

The computer system 400 may additionally include a computer-readable storage media reader 424; a communications system 428 (e.g., a modem, a network card (wireless or wired), an infra-red communication device, etc.); and working memory 436, which may include RAM and ROM devices as described above. The computer system 400 may also include a processing acceleration unit 432, which can include a Digital Signal Processor (DSP), a special-purpose processor, and/or the like.

The computer-readable storage media reader 424 can further be connected to a computer-readable storage medium, together (and, optionally, in combination with storage device(s) 420) comprehensively representing remote, local, fixed, and/or removable storage devices plus storage media for temporarily and/or more permanently containing computer-readable information. The communications system 428 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 400 may also comprise software elements, shown as being currently located within a working memory 436, including an operating system 440 and/or other code 444. It should be appreciated that alternate embodiments of a computer system 400 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 408 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Regardless of whether the solar calculator is executed by a stand-alone computing device, is provided by a server, e.g., as a web service, or some combination thereof, the solar calculator can provide a number of user interfaces through which a user can interact with the solar calculator. For example, one user interface may be provided through which the user can enter basic information about a project to be used by the solar calculator. Additionally, or alternatively, a user interface may be provided by the solar calculator through which the user can enter more specific information about the building's roof. In some cases, one or more interfaces may be provided through which the solar calculator may present a report or other output of results. For example, the solar calculator may output an engineering layout which shows the arrangement of solar panels on the roof and mounting points for the roof seams and each solar panel.

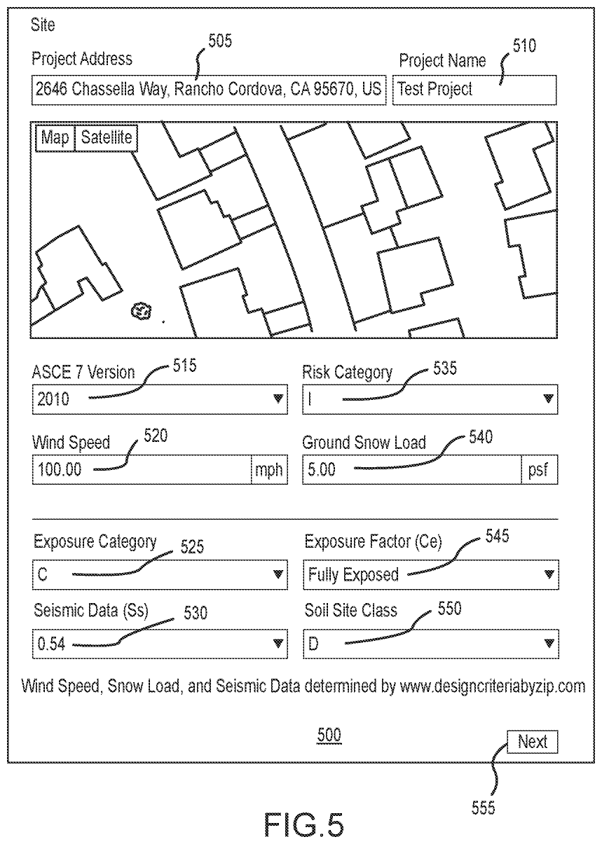

FIG. 5 is a screenshot of an exemplary site information input screen according to one embodiment of the present disclosure. As illustrated in this example, the interface can include an aerial image of the building and possibly a surrounding area. Additionally, or alternatively, the interface can include a number of elements such as text boxes, combo boxes, etc. through which the user can enter information including, but not limited to, the project address, a project name, maximum wind speed and exposure information, seismic and/or soil data, and possibly other information.

More specifically, and as illustrated in this example, the interface 500 can include text 505 presenting an address for a project and text 510 presenting a name for the project. The interface 500 can further comprise a combo-box 515 through which a user can select an engineering standard to be applied, a textbox 520 through which the user can enter a maximum wind speed the roof is expected to withstand, a combo-box 525 through which the user can select an exposure category for the roof, and/or a textbox through which the user can enter seismic data for the geographic area of the building. Additionally, or alternatively, the interface 500 can include a combo-box 535 through which the user can select a risk category for the building, a textbox 540 through which the user can enter a maximum snow load the building is expected to encounter, a combo-box 545 through which the user can select an exposure factor for the roof of the building, and a combo-box 550 through which the user can select a soil site class for the building. Finally, the interface 500 can include a button 555 or other control for submitting or confirming the selections.

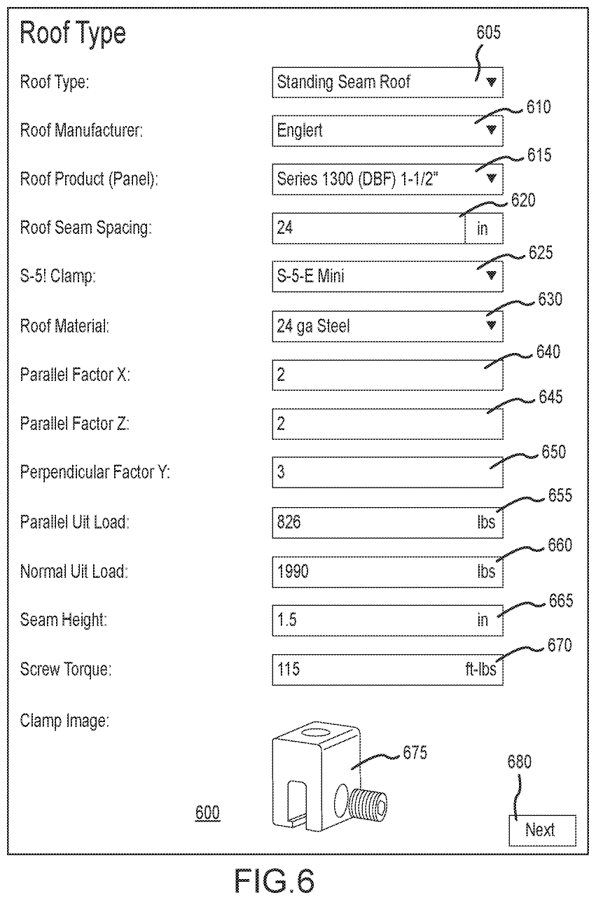

FIG. 6 is a screenshot of an exemplary roof type input screen according to one embodiment of the present disclosure. As illustrated in this example, the interface can include a number of elements such as text boxes, combo boxes, etc. through which the user can enter various information related to the roof of the building onto which the solar panels will be installed. This information can include, but is not limited to, a roof type, a roof manufacturer, a product used on the roof, roof seam spacing, a type of fastener (or “clamp”) to be used to mount the solar panels, a roof material used, various parameters related to the load of the solar panels, etc.

More specifically, and as illustrated in this example, the interface 600 can include a combo-box 605 through which the user can select a roof type for the building, a combo-box 610 through which the user can select a roof manufacturer for the building, a combo-box 615 through which the user can select a product or panel used on the roof of the building, a combo-box 620 through which the user can select a roof seam spacing for the roof, a combo-box 625 through which the user can select a type of clamp to be used to mount the solar panels to the roof, and a combo-box 630 through which the user can select a roof material installed on the building. Additionally, or alternatively, the interface may include one or more textboxes 640, 645, and 650 through which the user may enter a loading factor in one or more axis relative to the roof surface. The interface 600 can additionally, or alternatively, include a number of textboxes or fields presenting specifications for the installation. For example, the interface can include a text field 655 presenting a parallel load value, a text field 660 presenting a normal load value, a text field 665 presenting a seam height for the roof, and text field 670 presenting a torque value for the clamp screw. In some cases, the interface may also include an image 675 of the clamp selected. Finally, the interface 600 can include a button 680 or other control for submitting or confirming the selections.

It should be understood that the exemplary user interfaces 500 and 600 described above are offered by way of example only and are not intended to limit the scope of the present disclosure. Rather, the actual interfaces presented by embodiments of the present disclosure can vary greatly depending upon the exact implementation. For example, different interfaces may include more, fewer, and/or different elements in different formats and arrangements. Any such variations are considered to be within the scope of the present disclosure.

As described above, the solar calculator can use such information as described above to calculate a layout for the solar panel installation that can include not only the location and spacing of the panels but also the number of fasteners used and the spacing and/or location of those fasteners. Such results can be presented, for example, in the form of one or more reports. The reports can include, but are not limited to, one or more graphical representations of the arrangement of the solar panels on the roof of the building, a project summary, an overview of the solar panel system used, a summary of design criteria used, details of the roof itself, and/or a bill of materials for the mounting hardware and type of fastener used. Such reports can be provided in the form of a printed paper report, as an electronic file, or in the form of a user interface such as a web page.

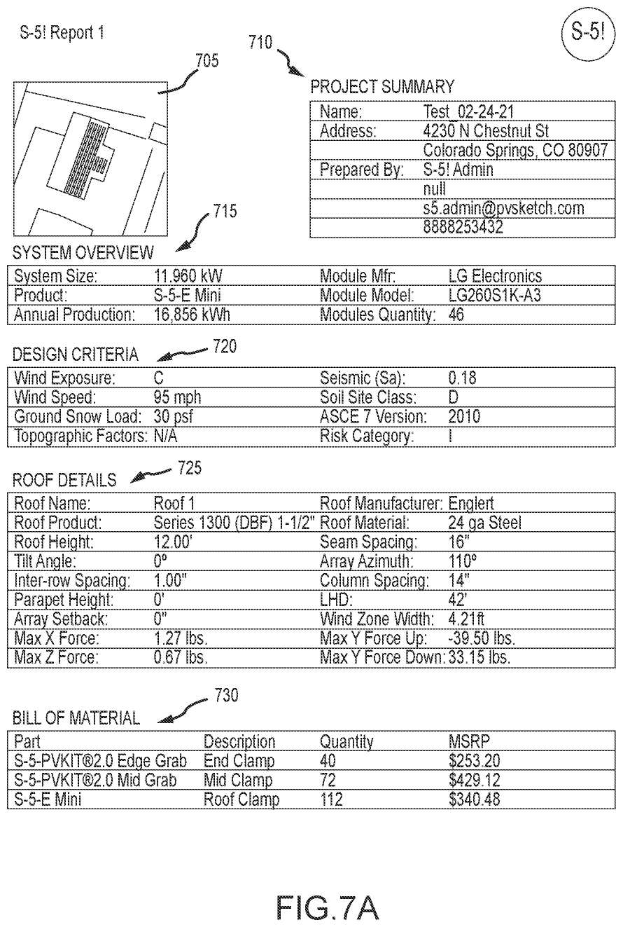

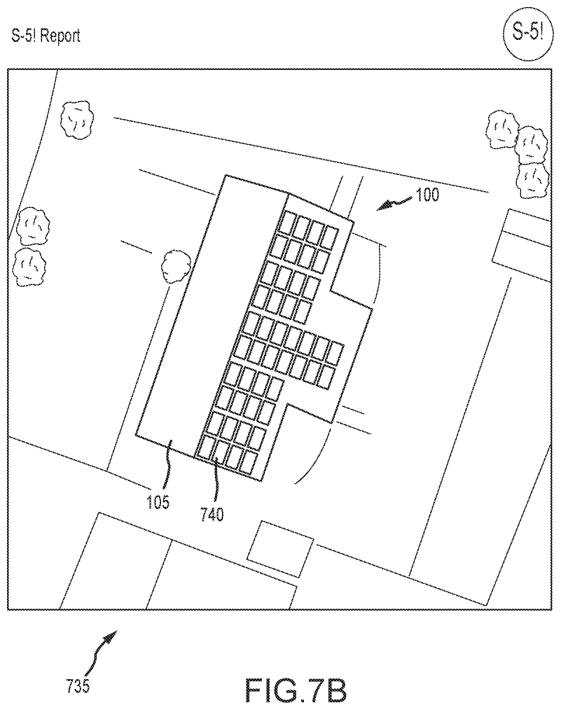

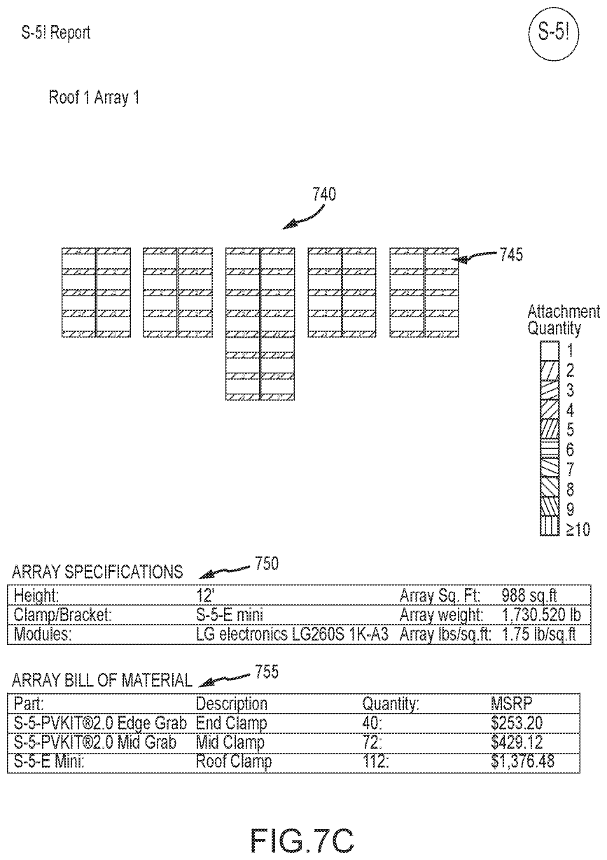

FIGS. 7A-7C illustrate examples of reports which can be generated by embodiments of the present disclosure. More specifically, and as illustrated in FIG. 7A, the report can include an image 705 of the building, a project summary section 710 providing a project name, an address or location for the project, a system overview section 715 providing details of system size, solar panel manufacturer, mounting product name, solar panel model number, annual output for the array, and number of panels, a design criteria section 720 providing wind exposure, seismic, wind speed, soil site class, ground snow load, ASCE 7 version, topographical factors, and risk category data, a roof details section 725 providing various details about the roof of the building, and a bill of materials section 730 providing a list of mounting hardware. As shown in FIG. 7B, the report can additionally, or alternatively, include an image 735 of the building showing the location and arrangement of the solar panel array 740 on the roof 105 of the building 100. Additionally, or alternatively, as shown in FIG. 7C, the report can include a representation of the solar array 740 showing each solar panel 745 and can further include an array specification section 750 providing various specification details for the array and a bill of materials section 755 for the array.

It should be understood that the exemplary report described above is offered by way of example only and are not intended to limit the scope of the present disclosure. Rather, the actual report generated by embodiments of the present disclosure can vary greatly depending upon the exact implementation. For example, different reports may include more, fewer, and/or different elements in different formats and arrangements. Any such variations are considered to be within the scope of the present disclosure.

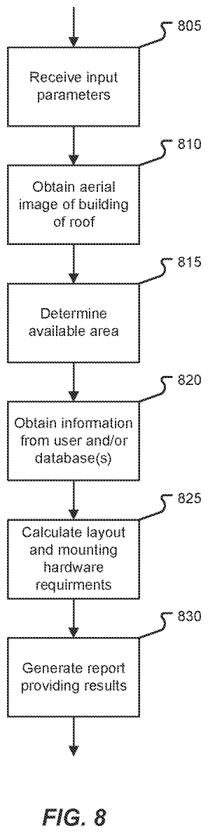

FIG. 8 is a flowchart illustrating an exemplary process for calculating a solar panel installation layout according to one embodiment of the present disclosure. As illustrated in this example, calculating a layout for a set of solar panels to be installed on a roof of a building can comprise receiving 805 input parameters defining requirements for the solar panels. The input parameters can comprise, for example, one or more of project information, roof information for the roof of the building, a three-dimensional model or rendering of the roof of the building, site information for the building, and/or system requirements for the solar panels. These parameters can be received 805 via a user interface such as described above, for example.

An aerial image of the roof of the building can be obtained 810 and an available area for the solar panels can be determined 815 based on the aerial image. Such an image can be obtained 810, for example, by a drone, aircraft, satellite or other platform. According to one embodiment, the image can be obtained 810 from an online service providing such images such as Goggle Maps or Google Earth, for example. Determining 815 the available area for the solar panels can comprise, for example, using available machine vision software to identify edges of the roof from the aerial image as well as obstacles or obstructions on the roof such as chimneys, Heating Ventilation And Cooling (HVAC) units, etc. In other cases, the image can be presented on a graphical user interface and the available area can be determined based on user input through the interface, e.g., by the user drawing or tracing an outline of the area.

Structural information for the installation of the solar panels can also be obtained 820. The structural information for the installation of the solar panels can comprise one or more of specifications for hardware to mount the solar panels, specifications for the solar panels, a three-dimensional model or rendering of the solar panels, and/or wind data for the building. Such information can be obtained 820 from a user, e.g., through an interface such as described above, or from one or more publicly available and/or proprietary databases.

A layout for the solar panels, required hardware for mounting the solar panels on the roof of the building, and locations for the required hardware can be calculated 825 based on the received input parameters, the determined available area for the solar panels, and the obtained structural information for the installation of the solar panels. Generally speaking, calculating 825 the layout of the solar panels can comprise positioning the solar panels and the mounting hardware on the roof so that the panels and mounting hardware align with seams, ribs, or corrugations on the roof so that the hardware can be clamped to the seams of the roof without a need to drill into the roof. Additional details of an exemplary process for calculating 825 a layout for the solar panels will be described below.

A report providing the calculated layout and mounting hardware requirements can be generated 830. The report can comprise a graphical and/or textual representation of the results presented on a display device and/or printed. The report can present and describe the layout of the solar panels and hardware, a bill of materials for the installation, and other information.

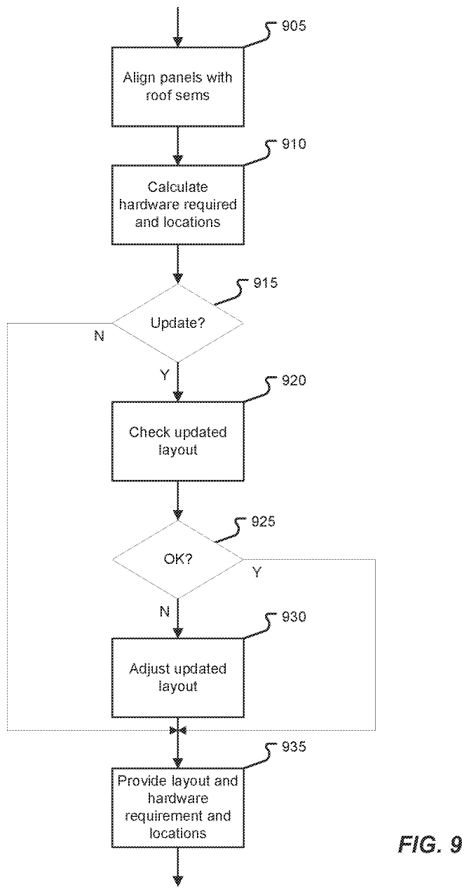

FIG. 9 is a flowchart illustrating additional details of an exemplary process for calculating a solar panel installation layout according to one embodiment of the present disclosure. As illustrated in this example, calculating a layout for the solar panels can comprise aligning 905 a mounting location of each solar panel with a seam of the roof of the building. Aligning 905 the mounting location of each solar panel with seams of the roof of the building can be accomplished, for example, by the solar calculator application manipulating a three-dimensional model or rendering of the solar panels and roof. In some cases, the layout for the solar panels can comprise a gap between two or more adjacent solar panels. For example, the gap between the two or more adjacent solar panels can comprise a predetermined distance allowing for thermal expansion of the two or more adjacent solar panels. In such cases, aligning 905 the mounting location of each solar panel with seams of the roof of the building can comprise adjusting the gap between the two or more adjacent solar panels to align a mounting location of each solar panel with a seam of the roof of the building.

Required hardware for mounting the solar panels on the roof of the building and locations for the required hardware can be calculated 910. Calculating 910 the required hardware can be based on a building code for a geographic region of the building, loads and forces the panels may be subject to, e.g., wind loads, snow loads, etc., and specifications for the hardware. For example, building codes and/or requirements such as the American Society of Civil Engineers (ASCE) standards or an equivalent for the geographic location of the building can be referenced. Such a standard can provide tables defining the requirements for the geographic location and a tabular calculation can be performed on this table to identify the hardware requirements and the hardware can then be selected according to the hardware specifications. Locations for the hardware can be determined, for example, based on a two-dimensional drawing, a three-dimensional model or image of the panel, etc.

In some cases, after calculating the layout for the solar panels, required hardware for mounting the solar panels on the roof of the building, and the locations for the required hardware, an update to the calculated layout for the solar panels may be received. For example, a user may make an adjustment, i.e., move some of the panels, in a rendering of the layout presented in a graphical user interface. In such cases, a determination 915 can be made as to whether such an update has been received. In response to determining 915 there has not been such an update, the calculated layout for the solar panels can be provided 935 in the generated report.

In response to determining 915 there has been such an update, the updated layout can be checked 920 by generating a determined layout similar to the updated layout, i.e., by again aligning 905 the panels and calculating 910 hardware requirements for the updated layout. A determination 925 can then be made as to whether the update to the calculated layout for the solar panels is acceptable, i.e., whether the update to the calculated layout for the solar panels matches the determined layout for the solar panels. In response to determining 925 the update to the calculated layout for the solar panels matches the determined layout for the solar panels, the update to the calculated layout for the solar panels can be provided 935 in the generated report. In response to determining 935 the update to the calculated layout for the solar panels does not match the determined layout for the solar panels, the update to the calculated layout for the solar panels can be adjusted 930, e.g., to match the determined layout, and the adjusted update to the calculated layout for the solar panels can be provided 935 in the generated report.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for calculating a layout for a set of solar panels to be installed on a roof of a building, the method comprising:
receiving, by a computing system, input parameters defining requirements for the solar panels;
obtaining, by the computing system, an aerial image of the roof of the building;
determining, by the computing system, an available area for the solar panels based on the aerial image;
obtaining, by the computing system, structural information for the installation of the solar panels;
calculating, by the computing system, a layout for the solar panels, required hardware for mounting the solar panels on the roof of the building, and locations for the required hardware based on the received input parameters, the determined available area for the solar panels, and the obtained structural information for the installation of the solar panels; and
generating, by the computing system, a report providing the calculated layout and mounting hardware requirements.

2. The method of claim 1, wherein the input parameters comprise one or more of project information, roof information for the roof of the building, site information for the building, or system requirements for the solar panels.

3. The method of claim 1, wherein the structural information for the installation of the solar panels comprises one or more of specifications for hardware to mount the solar panels, specifications for the solar panels, or wind data for the building.

4. The method of claim 3, wherein the structural information for the installation of the solar panels is obtained from one or more databases.

5. The method of claim 3, wherein the structural information for the installation of the solar panels is obtained from a user of the computing system.

6. The method of claim 1, wherein calculating a layout for the solar panels comprises aligning a mounting location of each solar panel with a seam of the roof of the building and wherein calculating required hardware for mounting the solar panels on the roof of the building and locations for the required hardware is further based on a building code for a geographic region of the building.

7. The method of claim 6, further comprising, after calculating the layout for the solar panels, required hardware for mounting the solar panels on the roof of the building, and the locations for the required hardware:
receiving, by the computer system, an update to the calculated layout for the solar panels;
determining, by the computer system, whether the update to the calculated layout for the solar panels matches a determined layout for the solar panels;
in response to determining the update to the calculated layout for the solar panels matches the determined layout for the solar panels, providing the update to the calculated layout for the solar panels in the generated report; and
in response to determining the update to the calculated layout for the solar panels does not match the determined layout for the solar panels, adjusting the update to the calculated layout for the solar panels and providing the adjusted update to the calculated layout for the solar panels in the generated report.

8. The method of claim 1, wherein the layout for the solar panels comprises a gap between two or more adjacent solar panels and wherein calculating the layout for the solar panels comprises adjusting the gap between the two or more adjacent solar panels to align a mounting location of each solar panel with a seam of the roof of the building.

9. The method of claim 8, wherein the gap between the two or more adjacent solar panels comprises a predetermined distance allowing for thermal expansion of the two or more adjacent solar panels.

10. A system comprising:
a processor; and
a memory coupled with and readable by the processor and storing therein a set of instructions which, when executed by the processor, causes the processor to calculate a layout for a set of solar panels to be installed on a roof of a building by:
receiving input parameters defining requirements for the solar panels;
obtaining an aerial image of the roof of the building;
determining an available area for the solar panels based on the aerial image;
obtaining structural information for the installation of the solar panels;
calculating a layout for the solar panels, required hardware for mounting the solar panels on the roof of the building, and locations for the required hardware based on the received input parameters, the determined available area for the solar panels, and the obtained structural information for the installation of the solar panels; and
generating a report providing the calculated layout and mounting hardware requirements.

11. The system of claim 10, wherein the input parameters comprise one or more of project information, roof information for the roof of the building, site information for the building, or system requirements for the solar panels and wherein the structural information for the installation of the solar panels comprises one or more of specifications for hardware to mount the solar panels, specifications for the solar panels, or wind data for the building.

12. The system of claim 10, wherein calculating a layout for the solar panels comprises aligning a mounting location of each solar panel with a seam of the roof of the building and wherein calculating required hardware for mounting the solar panels on the roof of the building and locations for the required hardware is further based on a building code for a geographic region of the building.

13. The system of claim 12, wherein the instruction further cause the processor to, after calculating the layout for the solar panels, required hardware for mounting the solar panels on the roof of the building, and the locations for the required hardware:
receive an update to the calculated layout for the solar panels;
determine whether the update to the calculated layout for the solar panels matches a determined layout for the solar panels;
in response to determining the update to the calculated layout for the solar panels matches the determined layout for the solar panels, provide the update to the calculated layout for the solar panels in the generated report; and
in response to determining the update to the calculated layout for the solar panels does not match the determined layout for the solar panels, adjust the update to the calculated layout for the solar panels and providing the adjusted update to the calculated layout for the solar panels in the generated report.

14. The system of claim 10, wherein the layout for the solar panels comprises a gap between two or more adjacent solar panels and wherein calculating the layout for the solar panels comprises adjusting the gap between the two or more adjacent solar panels to align a mounting location of each solar panel with a seam of the roof of the building.

15. The system of claim 14, wherein the gap between the two or more adjacent solar panels comprises a predetermined distance allowing for thermal expansion of the two or more adjacent solar panels.

16. A non-transitory, computer-readable medium comprising a set of instructions stored therein which, when executed by a processor, causes the processor to calculate a layout for a set of solar panels to be installed on a roof of a building by:
receiving input parameters defining requirements for the solar panels;
obtaining an aerial image of the roof of the building;
determining an available area for the solar panels based on the aerial image;
obtaining structural information for the installation of the solar panels;
calculating a layout for the solar panels, required hardware for mounting the solar panels on the roof of the building, and locations for the required hardware based on the received input parameters, the determined available area for the solar panels, and the obtained structural information for the installation of the solar panels; and
generating a report providing the calculated layout and mounting hardware requirements.

17. The non-transitory, computer-readable medium of claim 16, wherein the input parameters comprise one or more of project information, roof information for the roof of the building, site information for the building, or system requirements for the solar panels and wherein the structural information for the installation of the solar panels comprises one or more of specifications for hardware to mount the solar panels, specifications for the solar panels, or wind data for the building.

18. The non-transitory, computer-readable medium of claim 16, wherein calculating a layout for the solar panels comprises aligning a mounting location of each solar panel with a seam of the roof of the building and wherein calculating required hardware for mounting the solar panels on the roof of the building and locations for the required hardware is further based on a building code for a geographic region of the building.

19. The non-transitory, computer-readable medium of claim 18, wherein the instructions further cause the processor to, after calculating the layout for the solar panels, required hardware for mounting the solar panels on the roof of the building, and the locations for the required hardware:
receive an update to the calculated layout for the solar panels;
determine whether the update to the calculated layout for the solar panels matches a determined layout for the solar panels;
in response to determining the update to the calculated layout for the solar panels matches the determined layout for the solar panels, provide the update to the calculated layout for the solar panels in the generated report; and
in response to determining the update to the calculated layout for the solar panels does not match the determined layout for the solar panels, adjust the update to the calculated layout for the solar panels and providing the adjusted update to the calculated layout for the solar panels in the generated report.

20. The non-transitory, computer-readable medium of claim 16, wherein the layout for the solar panels comprises a gap between two or more adjacent solar panels and wherein calculating the layout for the solar panels comprises adjusting the gap between the two or more adjacent solar panels to align a mounting location of each solar panel with a seam of the roof of the building and wherein the gap between the two or more adjacent solar panels comprises a predetermined distance allowing for thermal expansion of the two or more adjacent solar panels.
